(19) United States
(12) Patent Application Publication
(10) Pub. No.: US 2009/0315268 A1
(43) Pub. Date: Dec. 24, 2009

(54) Radial Crimp Seal

(75) Inventors: Kathryn M McCauley, Durand, MI (US); David Reid, Davison, MI (US)

Correspondence Address: DELPHI TECHNOLOGIES, INC., M/C 480-410-202, PO BOX 5052, TROY, MI, 48007, US

(73) Assignee: DELPHI TECHNOLOGIES, INC., Troy, MI (US)

(21) Appl. No.: 12/143,538

(22) Filed: Jun. 20, 2008

(51) Int. Cl. F02F 11/00

(52) U.S. Cl. 277/313; 277/591

(57) ABSTRACT

A sealed joint for a gas sensor as described which includes a sensor shell having an attachment portion and a sealing portion. The sealing portion has an inner recessed section and an outer protruding section terminating at a free end of the shell, the outer protruding section having an outer section diameter which is greater than the diameter of the inner section. The sealed joint also has an upper shield having a shell portion disposed around the sealing portion of the shell and a connector portion which extends upwardly away from the shell portion. The sealed joint includes a first radial crimp of the upper shield proximate the inner recessed section and a second radial crimp of the upper shield in the connector portion proximate the shell portion, such that the second crimp has a crimp diameter which is less than the outer section diameter of the shell. The structure described has a sealed joint between the sealing portion of the shell and the shell portion of the upper portion located between the first crimp and the second crimp.

### TECHNICAL FIELD

An exemplary embodiment of the present invention relates generally to high temperature gas sensors and, more particularly, to sealed joints used in high temperature gas sensors.

### BACKGROUND OF THE INVENTION

Combustion engines that run on fossil fuels generate exhaust gases. The exhaust gases typically include oxygen as well as various undesirable pollutants. Non-limiting examples of undesirable pollutants include nitrogen oxide gases (NOx), unburned hydrocarbon gases (HC), and carbon monoxide gas (CO). Various industries, including the automotive industry, use exhaust gas sensors to both qualitatively and quantitatively sense and analyze the composition of the exhaust gases for engine control, performance improvement, emission control and other purposes, such as to sense when an exhaust gas content switches from a rich to lean or lean to rich air/fuel ratio. For example, HC emissions can be reduced using sensors that can sense the composition of oxygen gas (O₂) in the exhaust gases for alteration and optimization of the air to fuel ratio for combustion.

A conventional high temperature gas sensor typically includes an ionically conductive solid electrolyte material, a porous electrode on the sensor's exterior exposed to the exhaust gases with a porous protective overcoat, a porous electrode on the sensor's interior surface exposed to a known gas partial pressure, an embedded resistance heater and electrical contact pads on the outer surface of the sensor to provide power and signal communication to and from the sensor. An example of a sensor used in automotive applications uses a yttria-stabilized, zirconia-based electrochemical galvanic cell with porous platinum electrodes to detect the relative amounts of oxygen present in an automobile engine's exhaust. When opposite surfaces of this galvanic cell are exposed to different oxygen partial pressures, an electromotive force (emf) is developed between the electrodes on the opposite surfaces of the electrolyte wall, according to the Nernst equation.

Exhaust sensors that include various flat-plate ceramic sensing element configurations formed of various layers of ceramic and electrolyte materials laminated and sintered together with electrical circuit and sensor traces placed between the layers, and embedded resistance heaters and electrical contact pads on the outer surface of the sensor to provide power and signal communication to and from the sensors have become increasingly popular. These flat-plate sensors generally have a sensing portion or end, that is exposed to the exhaust gases and a reference portion or end, that is shielded from the exhaust gases providing an ambient reference. Gas sensors that employ these elements generally use lower shields that cover and protect the sensing portions of the flat plate sensing elements while enabling exposure of the sensor elements to the hot exhaust gases. Additionally, they have various inner seal arrangements disposed between the sensing portion and the reference portions that seal and prevent gas leakage along the surface of the sensor elements. They also have upper shields that are disposed around the reference portions of the sensors and that have gas-tight outer seals between the sensor shells and upper shields to exclude exhaust gases from the reference portions of the sensors. These seals may be formed by crimping or welding, such as laser welding, with crimping often being preferred due to equipment cost and equipment maintenance considerations associated with laser welding.

The outer seals are generally formed by crimping portions of the upper shields onto a surface of the shell or otherwise forming an interference fit between them. Various crimped and interference configurations are known. Such connections frequently do not provide a sufficient gas-tight seal, so various gasket materials have been used to enhance the seal. One example of a gasket material is a talc gasket, which is typically applied to the joint prior to crimping or forming the interference fit as a ring of a slurry or paste of talc and alcohol, known as talcohol. While useful to form the required seal, gasket materials such as those formed from talcohol are subject to variability in their sealing effectiveness if the amount of talcohol is not sufficient, or the slurry or paste is not mixed in the right proportions. In addition, the application of a paste or slurry to the otherwise dry sensor assembly process is undesirable due to cost considerations. Thus, while gas-tight sealed joints have been formed in the manner described above, there remains a need for improved sealed joints, particularly those which reduce or eliminate the need for use of gasket materials to effectuate the gas-tight seal.

### SUMMARY OF THE INVENTION

In general terms, this invention provides an improved sealed joint for a high temperature gas sensor which significantly reduces or eliminates the need for use of gasket materials to effectuate the gas-tight seal between the upper shield and the sensor shell.

An exemplary embodiment of the present invention provides a sealed joint for a gas sensor. The sealed joint includes a sensor shell having an attachment portion and a sealing portion. The sealing portion has an inner section and an outer section terminating at a free end of the shell. The outer section has an outer section diameter and the inner section has an inner section diameter, wherein the outer section diameter is greater than the inner section diameter. The sealed joint also includes an upper shield having a shell portion disposed around the sealing portion of the shell and the connector portion extending upwardly away from the shell portion. The sealed joint also includes a first radial crimp of the upper shield proximate the inner section that generally forms the shell portion of the upper shield to the inner section and outer section of the shell. The sealed joint also includes a second radial crimp of the upper shield and the connector portion proximate the shell portion. The second crimp has a crimp diameter that is less than the outer section diameter of the shell. This configuration provides a sealed joint between the sealing portion of the shell and the shell portion of the upper shield located between the first crimp and the second crimp.

The sealed joint may also include a gasket interposed in the sealed joint between the sealing portion of the shell and the shell portion of the upper shield. The gasket may include talc.

The sealed joint may also be formed such that the shell portion of the upper shield is plastically or elastically deformed between the first crimp and the second crimp.

Another exemplary embodiment of the invention provides a method of making a sealed joint for a gas sensor. The method includes the step of forming a sensor shell having an attachment portion and a sealing portion, the sealing portion having an inner section and an outer section terminating at the free end of the shell, the outer section having an outer section diameter and the inner section having an inner section diameter, wherein the outer section diameter is greater than the inner section diameter. The method also includes the step of forming an upper shield having a shell portion adapted for disposition around the sealing portion of the shell and a connector portion extending upwardly away from the shell portion. The method also includes the step of placing the shell portion of the upper shield over the sealing portion of the shell. The method also includes the method of crimping the upper shield to form a first radial crimp proximate the inner section that generally forms the shell portion of the inner shield to the inner section and the outer section of the shell. The method also includes the step of crimping the upper shield to form a second radial crimp in the connector portion proximate the shell portion. The second crimp has a crimp diameter that is less than the outer section diameter of the shell, whereby the sealed joint is formed between the sealing portion of the shell and the shell portion of the upper shield located between the first crimp and the second crimp. The steps of crimping the first radial crimp and crimping the second radial crimp may be performed as a single crimping step.

The method may also include the step of placing a gasket between the sealing portion of the shell and the shell portion of the upper shield prior to crimping. The step of placing a gasket may include depositing a ring of fluid gasket material, such as talcohol.

These and other features and advantages of this invention will become more apparent to those skilled in the art from the detailed description of a preferred embodiment. The drawings that accompany the detailed description are described below.

### BRIEF DESCRIPTION OF THE DRAWINGS

The following is a brief description of the drawings wherein like elements are numbered alike in the several views:

FIG. 1 is a cross-sectional view of an exemplary embodiment of a sealed joint in a high temperature gas sensor according to the invention;

FIG. 2 is an enlarged cross-sectional view of region 2 of FIG. 1;

FIG. 3 is a top view of a precursor upper shield;

FIG. 4 is a cross-sectional view of the precursor upper shield of FIG. 3 taken along section 4-4;

FIG. 5 is a perspective view of the precursor upper shield of FIG. 3;

FIG. 6 is a schematic cross-sectional view illustrating the insertion of precursor upper shield onto the sensor-connector subassembly; and

FIG. 7 is an enlarged cross-sectional view of region 7 of FIG. 6 following insertion of the upper shield onto the sensor-connector subassembly.

### DETAILED DESCRIPTION OF A PREFERRED EMBODIMENT

An exemplary embodiment of the present invention provides an improved seal joint for a high temperature gas sensor that significantly reduces or eliminates the need for use of gasket materials to effectuate the gas-tight seal between the upper shield and the sensor shell. A particular advantage of the radial seal of the invention is that it may be used to seal gas sensors which are very compact, including those having an M12×1.25 thread form, 14mm wrench flats and an overall length of about 46.5 mm, a smaller lower shield having a diameter of only about 5.3 mm and protruding length of about 10.5 mm and a smaller sensor element having a width of about 2.4 mm, a length of about 27 mm and a thickness of about 0.82 mm. This small overall profile gas sensor provides much more flexibility in the mounting of the sensor, including access to various manifolds, conduits and other mounting points which were previously too small in themselves, or inaccessible due to the larger envelope of free space required to place or attach larger sensors due to the interference constraints associated with other vehicle or engine components. The reduced profile also provides a benefit with regard to material cost savings due to the reduced amounts of material required for most of the sensor components. The smaller thread size also enables mounting the sensors in smaller diameter and smaller length exhaust pipes and other conduits. Further, the smaller cross-section of the lower shield and sensing end of the sensor reduces intrusion into and interference with the exhaust stream. Still further, the smaller gas sensor houses a much smaller flat-plate ceramic sensing element that requires less power for activation (burn-ofo) of the sensor and a shorter sensor response times, thereby reducing the power load on the electrical systems and improving the responsiveness of the vehicle emission control systems of vehicles which utilize these sensors. The improvement of the sealed joint despite the smaller size of the associated components, including the diameters of the sensor shell and the upper shield is a very advantageous aspect of the present invention.

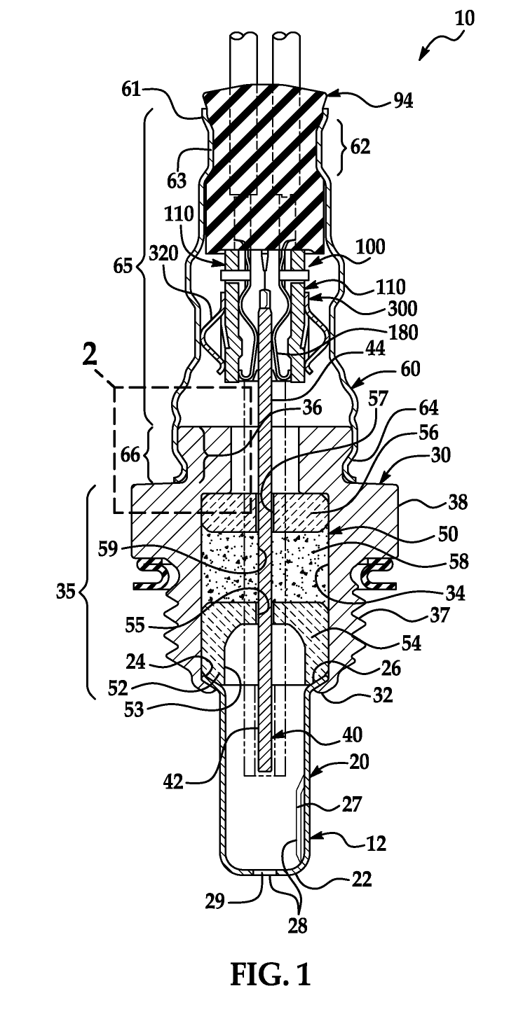

FIG. 1 illustrates a high-temperature gas sensor 10 which is adapted to qualitatively and quantitatively sense various exhaust gases, such as O₂, NOₓ, HC, CO and the like, which incorporates an exemplary embodiment of the gas-tight radial seal between the upper shield and the sensor shell. An exemplary embodiment of gas sensor 10 includes a generally cylindrical lower shield 20, sensor shell 30, flat-plate ceramic sensor 40, sensor packing 50, upper shield 60 and connector assembly 100. Gas sensor 10 is suitable for exposure in a high temperature exhaust gas stream, including operating temperatures up to about 1000° C. at the sensing end 12 that is located in the exhaust gas stream, such as those found in the exhaust system of an internal combustion engine, including those used in many vehicular applications.

Lower shield 20 is a substantially cylindrical form having a substantially closed end 22 and an open end 24. Open end 24 may include an outwardly extending flange 26 in the form of a straight taper or arcuate flair or other suitable flange form. Lower shield 20 is preferably formed of a metal that is adapted for high-temperature performance including resistance to high temperature oxidation and corrosion, particularly as found in high temperature exhaust gases and corrosive combustion exhaust byproducts associated with the exhaust stream of an internal combustion engine. Suitable metals include various ferrous alloys, such as stainless steels, including high chrome stainless steel, high nickel stainless steel, as well as various Fe-base, Ni-base, and Cr-base superalloys. The various ferrous and other alloys described above are generally indicative of a wide number of metal alloys that are suitable for use as lower shield 20. In an exemplary embodiment, lower shield 20 may be formed from type 310 stainless steel (UNS 31008) and may have an outer diameter of about 5.3 mm and an exposed length (i.e., below the deformed shoulder 32) of about 10.5 mm. Lower shield 20 abuts a lower end 62 of packing 50 and applies a compressive force thereto by the operation of deformed shoulder 32 at a lower end of shell 30. Deformed shoulder 32 presses against the outer surface of outwardly extending flange 26 and acts to retain both lower shield 20 and packing 50 within central bore 34 of shell 30. Lower shield 20 also includes one or more orifice 28 in the form of a bore 29, or louver 27 formed by piercing and inwardly bending the sidewall. Bore 29 may have any suitable shape, including various cylindrical, elliptical and slot-like shapes. Orifices 28 permit exhaust gases to enter the interior of lower shield 20 and come into contact with the lower or sensing end 42 of sensor 40 during operation of sensor 10, while at the same time, lower shield 20 provides a physical shield for sensor 40 against damage from the full fluid force of the exhaust gas stream, or from damage that may be caused by various mechanical or thermal stresses that result during installation or operation of sensor 10. While deformed shoulder 32 is illustrated for attachment of lower shield 20 in compressive engagement with packing 50, it will be appreciated that other means of attaching lower shield 20 to shell 30 while maintaining packing 50 in compressed engagement are possible, including various forms of weld joints, brazed joints and other attachment means and mechanisms.

In addition to deformed shoulder 32 and central bore 34, sensor shell 30 may be described generally as having an attachment portion 35 and a sealing portion 36. Attachment portion 35 may include a threaded form 37 which is adapted for threaded insertion and attachment into a component of the exhaust system of an internal combustion engine, such as an exhaust manifold or other exhaust system component, and tool attachment features 38, such as various forms of wrench flats (e.g. hex-shaped, double-hex and other wrench flat configurations). In an exemplary embodiment, shell 30 may have a thread form of M12×1.25 and a 14 mm hex wrench flats and be formed from Ni-plated steel. Shell 30 may be made from any material suitable for high-temperature exposure, including installation stresses associated with the threaded connection, mechanical stresses associated with usage of the device including various bending moments, thermal stresses and the like. Shell 30 will preferably be formed from a ferrous material, such as various grades of steel, including various plated or coated steels, such as those having various pure nickel or nickel alloy plating or coatings; however, the use of other metal alloys is also possible. While one embodiment of shell 30 is described herein, it will be appreciated by one of ordinary skill that many other forms of shell 30 may be used in conjunction with the present invention.

Referring again to FIG. 1, packing 50 is made up of a lower support disk 54, an upper support disk 56 and sealing member 58. Lower support disk 54 has a central slot 55 that is adapted to receive sensor 40 in closely spaced relation between slot 55 and the outer surface of sensor 40 proximate to slot 55. Generally, a substantially rectangular slot configuration provides closely spaced relation between lower support disk 54 and the outer surface of sensor 40. Lower support disk 54 may have a relieved portion 53 to provide spacing from sensor 40, and increase the exposure of the surface of sensor 40 to the exhaust gases that enter the interior of lower shield 20 during operation of sensor 10 in conjunction with operation of the associated internal combustion engine. Lower support disk 54 will generally be sized for slip-fit engagement with central bore 34 such that lower support disk 54 may be inserted into central bore 34 during assembly and yet have a minimal gap therebetween so as to reduce the tendency for leakage of exhaust gas between the outer surface of lower support disk 54 during operation of the sensor 10. The lower end 52 of the lower support disk 54 and central bore 34 may be tapered downwardly and inwardly or otherwise adapted for mating engagement with flange 26. Lower support disk 54 will generally be made from an electrically and thermally insulating, high-temperature ceramic material. Any suitable high-temperature ceramic material may be utilized, including various oxide, nitride or carbide ceramics or combinations thereof Any suitable material may be utilized which is compatible with the function of sensor 40 and the operation of sealing member 58 in the high temperature operating environment of sensor 10.

The upper end of lower support disk 54 compressively engages sealing member 58. Sealing member 58 is preferably a compressed insulating powder, such as a talc disk. The compressed powder material of sealing member 58 is both electrically and thermally insulating. Sealing member 58 also has a central slot 59 that is adapted to receive sensor 40 in closely spaced relation between slot 59 and the outer surface of sensor 40 proximate to slot 59, particularly during installation of sealing member 58 over sensor 40. Upon installation of packing 50, including the compressive loading described herein, sealing member 58 is in compressed sealing engagement with the sensor 40 on the interior thereof, and shell 30 on the exterior thereof. Upon compressive installation of packing 50, sealing member 58 is operative to prevent passage of hot exhaust gases, particularly those received through orifices 28, from passing between the packing 50 and central bore 34 or along the surface of sensor 40 to an upper end 44 thereof.

Upper support disk 56 is in pressing engagement with sealing member 58 and is adapted to retain sealing member 58, such as by preventing it from being extruded through an upper portion of central bore 34. Upper support disk 56 also includes a central slot 57 that is adapted to receive sensor 40 in a similar manner as central slot 55 of lower support disk 54. Upper support disk 56 is likewise adapted for slip-fit engagement with central bore 34 in the manner described for lower support disk 54. Upper support disk 56 may be made from any suitable high temperature material, including ceramics or other materials identical to those used for lower support disk 54. However, upper support disk may also be made from a separate material, including a different ceramic material than that of lower support disk 54. Since upper support disk 56 is located further from the exhaust gas stream than lower support disk 54 and generally is exposed to somewhat lower temperatures than lower support disk 54, it may be desirable in some applications to make upper support disk 56 from a different material than that of lower support disk 54. While one configuration of packing 50 has been described, it will be appreciated that many other forms of packing 50 may be used in conjunction with the present invention.

High temperature gas sensor 40 may be of any suitable internal and external configuration and construction. Gas sensor 40, is preferably a flat-plate sensor having the shape of a rectangular plate or prism. Gas sensor 40 will typically include an ionically conductive solid electrolyte material, a porous electrode on the sensors exterior which is exposed to the exhaust gases, a porous protective overcoat, a porous electrode on the interior of the sensor which is adapted for exposure to a known gas partial pressure, an embedded resistance heater and various electrical contact pads on the outer surface of the sensor to provide the necessary circuit paths for power and signal communication to and from the sensor. Depending on the arrangement of the various elements described above, gas sensor may be configured to quantitatively, qualitatively, or both, sense various constituents of the exhaust gas, including O₂, NOₓ, HC and CO. For automotive applications, an example of a suitable construction of sensor 40 would include a yttria-stabilized, zirconia-based electrochemical galvanic cell with porous platinum electrodes to detect the relative amounts of oxygen present in engine exhaust. When opposite surfaces of such a galvanic cell located at sensing end 42 and reference end 44 are exposed to different oxygen partial pressures, an electromotive force (EMF) is developed between electrodes located at these ends on the opposite surfaces of the electrolyte wall according to the Nernst Equation. In an exemplary embodiment, gas sensor may have the shape of a rectangular prism having a width of about 2.4 mm, a length of about 27 mm and a width of about 0.82 mm. While an exemplary embodiment of gas sensor 40 is described above, various configurations of gas sensor 40 are contemplated for use in conjunction with the exemplary embodiment of the invention, including gas sensors 40 which are adapted for sensing other exhaust gas constituents, and further including gas sensors having other dimensions and flat-plate configurations.

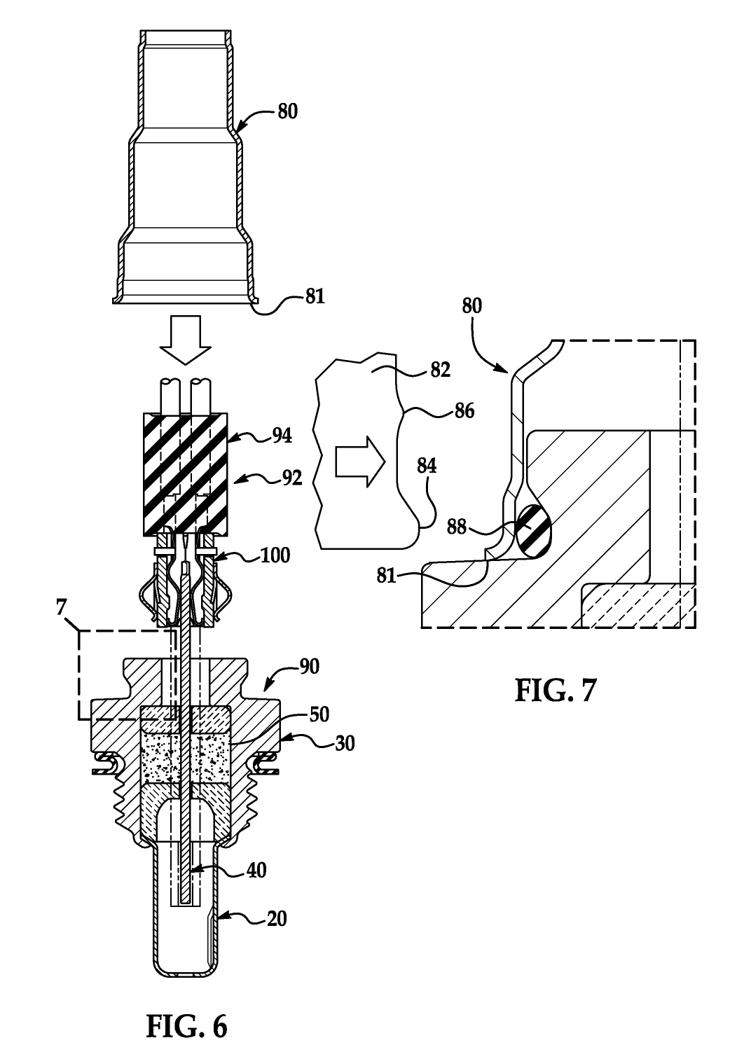

Referring to FIG. 6, in an exemplary embodiment, the lower shield 20, sensor shell 30, gas sensor 40 and packing 50 may be assembled in the manner described herein to form a sensor subassembly 90. The electrical connector 100 is inserted onto the sensor subassembly 90 by insertion of the upper or reference end 44 of sensor 40 into a sensor pocket on the insertion end of electrical connector 100, as shown in FIG. 6, to form a sensor/connector subassembly 92. Electrical connector 100 hinges open to receive sensor 40. It is preferred that sensor 40 and electrical connector 100 be configured so that upon insertion of the sensor subassembly 90, sufficient power and signal communication are established between the electrical terminals 180 of the electrical connector 100 and the electrical contacts (not shown) of sensor 40 to pretest the electrical connections between them. Once the necessary electrical connections are assured, the assembly of gas sensor 10 is completed by the addition of upper shield of 60 which formed from a precursor upper shield 80, as shown in FIGS. 6 and 7.

Referring again to FIGS. 3-7, the precursor upper shield 80 is installed over the sensor-connector subassembly 92 (FIG. 6) to the position shown in FIG. 7 so that the upper end 81 of precursor upper shield is located proximate, preferably in touching contact with, an upper shoulder of tool attachment feature 38. Precursor upper shield 80 is preferably formed of a metal that is adapted for high-temperature performance including resistance to high temperature oxidation and corrosion, particularly as found in high temperature exhaust gases and corrosive combustion exhaust byproducts associated with the exhaust stream of an internal combustion engine. Suitable metals include various ferrous alloys, such as stainless steels, including high chrome stainless steel, high nickel stainless steel, as well as various Fe-base, Ni-base, and Cr-base superalloys. The various ferrous and other alloys described above are generally indicative of a wide number of metal alloys that are suitable for use as precursor upper shield 80. In an exemplary embodiment, precursor upper shield 80 may be formed from type 304 stainless steel (UNS 30400). In an exemplary embodiment, precursor upper shield 80 may have an overall length of about 22 mm and an inner diameter that varies in three cylindrical sections of decreasing diameter from top to bottom of about 7 mm to about 11 mm. The precursor upper shield 80 is deformed, such as by crimping, to form upper shield 60.

Referring to FIG. 1, electrical connector 100 is adapted to provide an electrical connection for power and signal communication between sensor 40 and a device that is adapted to receive such communications, such as an engine or other controller while at the same time providing the required electrical isolation between the various circuit paths associated with the required power and signal communication. Electrical connector 100 is in spring-biased engagement within an upper end 61 of upper shield 60 through outwardly extending spring arms 320 associated with the connector retainer 300. Electrical connector 100 is a clamshell configuration of a pair of ceramic connector body portions 110 and the spring-bias closes the clamshell and ensures a sufficient contact pressure between the electrical terminals 180 of the connector and electrical contacts (not shown) located on the upper end 44 of sensor 40 to provide a low resistance electrical connection sufficient for signal and power communication between sensor 40 and a device, such as a controller, which is adapted to receive the signal.

Upper shield 60 is formed from a precursor upper shield 80, such as that shown in FIGS. 3-5. A gas-tight upper sealed joint 62 is formed in sensor 10 when precursor upper shield 80 as shown in FIGS. 3-5 is plastically deformed into upper shield 60 having the shape shown in FIG. 1. This deformation may include a plurality of crimps formed along the length of precursor upper shield 80. In an exemplary embodiment, these crimps may include a radial crimp formed along the upper end of 61 of upper shield 60 at the location where the radial crimp die, as shown partially in FIG. 7, contacts the upper portion of precursor upper shield 80. A gas-tight upper sealed joint 62 is formed when precursor upper shield 80 as shown in FIG. 7 is crimped and plastically deformed into upper shield 60 having the shape shown in FIG. 1. Crimp 63 provides pressing engagement between an inner surface of the upper end of upper shield 60 and an outer surface of elastomeric sealing member 94. Crimp 63 deforms precursor upper shield 80 at an upper end 82 thereof sufficiently to provide pressing engagement between upper shield 60 and elastomeric sealing member 94, including the deformation of elastomeric sealing member 94, thereby forming upper sealed joint 62. While shown as a single radial crimp 63 in FIG. 1, upper sealed joint 62 may also be formed by a plurality of radial crimps of the type described herein. Upper shield 60 has a shell portion 66 and a connector portion 65 that extends upwardly and away from shell 30 and generally includes the portions of upper shield 60 other than shell portion 66.

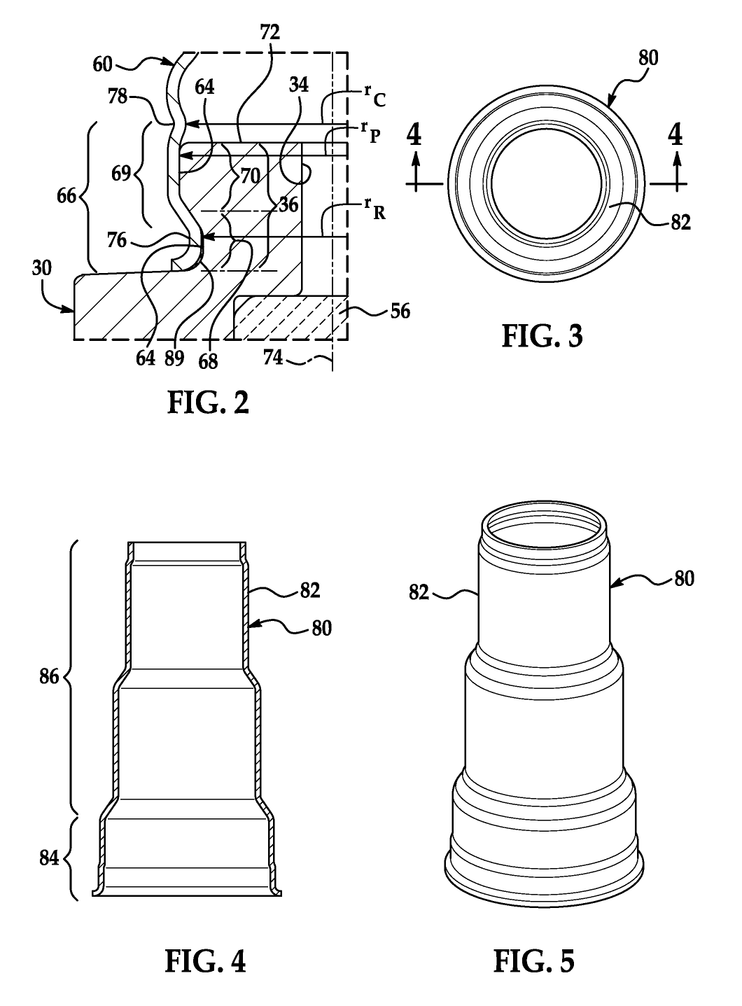

Sensor 10 also includes a lower sealed joint 64 between sealing portion 36 of shell 30 and the shell portion 66 of upper shield 60. Referring now to FIGS. 1 and 2, lower sealed joint 64 is a gas-tight sealed joint formed between the outer surface of sealing portion 36 of shell 30 and the inner surface of the shell portion 66 of upper shield 60. Sealing portion 36 of shell 30 includes an inner recessed section 68 and an outer protruding section 70 at an upper free end 72 of shell 30. Recessed section has a generally concave arcuate profile and protruding section 70 has a generally convex arcuate profile when viewed in section, such that the radius of shell 30 with reference to longitudinal axis 74 in recessed section 68 (r_{R}) is generally less than the radius of shell 30 in protruding section 70 (r_{P}). As such, the recessed section has a diameter along its length (d_{R}) that is less than the diameter of the outer protruding section along its length (d_{P}). More particularly, the recessed section has a maximum diameter along its length (d_{R}) that is less than the maximum diameter of the outer protruding section along its length (d_{P}). Lower sealed joint 64 is formed when precursor upper shield 80 is crimped and plastically deformed into upper shield 60 having the shape shown in FIG. 1. This deformation consists of a series of radial crimps formed along the length of upper shield 60 at the locations where the radial crimp die, as shown partially in FIG. 7, contacts precursor upper shield 80, particularly where inwardly protruding portions of the crimping die 84, 86 contact the precursor upper shield 80. In an exemplary embodiment, the maximum outer section diameter is about 11 mm.

Referring to FIGS. 2, 4 and 7, contact of protruding portion 84 of radial crimp die 82 with precursor upper shield 80 causes plastic deformation thereof and forms a first radial crimp 76 in upper shield 60. First radial crimp 76 in upper shield 60 has the shape of a radially inwardly extending circumferential groove formed in upper shield 60 at a lower end thereof Protruding portion 86 of radial crimp die 82 contacts precursor upper shield 80 causing plastic deformation and forms a second radial crimp 78 at a location just outwardly of and proximate to upper free end 72 of shell 30. Second radial crimp 78 has the shape of a radially inwardly extending annular or circumferential groove. Second radial crimp 78 has a radius (r_{C}) relative to longitudinal axis 74 that is less than r_{P} or a diameter (d_{C}) that is less than d_{P}. In an exemplary embodiment, the second crimp diameter is about 9.9 mm.

Since first radial crimp 76 fixes upper shield 60 against shell 30, second radial crimp 78 causes the intermediary portion 69 of shell section 66 to become either plastically deformed, or elastically deformed with the deformation being substantially permanent by the virtue of the intermediary portion 69 being stretched between the first radial crimp 76 and second radial crimp 78, depending on the amount of deformation associated with first radial crimp 76 and second radial crimp 78, their spacing and other factors. This deformation causes the material of intermediary portion 69 to be pressed into intimate contact with protruding section 70 of shell 30, and enhances the gas-tight seal formed between shell portion 66 of upper shield 60 and shield portion 36 of shell 30.

A gas-tight seal joint 64 having a leakage rate of less than 1 cc/min of air at 7.5 psi through lower seal joint 64 can be achieved without the use of additional gasket materials (not shown). With the addition of a gasket material 89 into lower seal joint 64, such as talc, a leakage rate of less than 0.1 cc/min of air at 7.5 psi through lower seal joint 64 has been observed. A gasket of the type described can be achieved by the addition of a circumferential bead of talcohol 88 as shown in FIG. 7 prior to the formation of lower seal joint 64 by the formation of first crimp 76 and second crimp 78. Either in conjunction with the manufacture of sensor 10 or its operation, the volatile constituents of the talcohol gasket material are volatilized leaving a gasket of compressed talc in lower sealed joint 64 between upper shield 60 and shell 30.

An exemplary embodiment of the invention herein also includes a method of making a sealed joint for a gas sensor which includes the steps of forming sensor shell 30 so as to include an attachment portion 35 and sealing portion 36 such that the sealing portion 36 has an inner recessed section 68 an outer protruding section 70 as described herein; forming a precursor upper shield 80 which has a shell portion 84 disposed around the sealing portion 36 of shell 30 and a connector portion 86 which extends upwardly away from shell portion 66; placing the shell portion 84 of the precursor upper shield 80 over the sealing portion 36 of shell 30; crimping the precursor upper shield 80 to form a first radial crimp 76 proximate inner recessed section 68 which generally conforms the shell portion 66 of upper shield 62 the inner recessed section 68 and protruding section 70 of shell 30; crimping precursor upper shield 80 to form second radial crimp 78 in connector portion 65 proximate shell portion 66 such that the second crimp 78 has a crimp diameter (d_{C}) which is less than the outer protruding section diameter (dₚ) of the shell 30, whereby a sealed joint is formed between the sealing portion 36 of the shell and the shell portion 66 of the upper shield 60 between first crimp 76 and second crimp 78. The steps of crimping to form the first radial crimp 76 and crimping to form the second radial crimp 78 may be performed as a single crimping step or as a plurality of crimping steps. Generally, it is preferred to use a multi-segment radial crimping die to form all of the crimps incorporated into upper shield 60 in a single crimping step. As noted above, the method of making sealed joint described herein may also include a step of placing a gasket material, such as talcohol, between sealing portion 36 of shell 30 and shell portion 84 of precursor upper shield 80 prior to the steps of crimping described above. The step of placing a gasket material may include depositing a ring of a fluid gasket material in a manner described herein prior to crimping of precursor upper shield 80.

The exemplary embodiments of the invention described herein are particularly advantageous in that they may be used to form a lower sealed joint for gas sensors having a substantially smaller size than related art gas sensors, as described herein. However, lower sealed joints and methods of their manufacture as described in the exemplary embodiments herein may also be employed in gas sensors having sizes which are typical of related art gas sensors with the advantage that the gas-tightness of the sealed joint may be improved over related art gas sensors, such as gas leakage rates of less than 0.1 cc per minute through the joint as described herein.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

What is claimed is:

1. A sealed joint for a gas sensor, comprising:
a sensor shell having an attachment portion and a sealing portion, the sealing portion having an inner section and an outer section terminating at a free end of the shell, the outer section having an outer section diameter and the inner section having an inner section diameter, wherein the outer section diameter is greater than the inner section diameter;
an upper shield having a shell portion disposed around the sealing portion of the shell and a connector portion extending upwardly away from the shell portion;
a first radial crimp of the upper shield proximate the inner section which generally conforms the shell portion of the upper shield to the inner section and outer section of the shell;
a second radial crimp of the upper shield in the connector portion proximate the shell portion, the second crimp having a crimp diameter which is less than the outer section diameter of the shell; and
a sealed joint between the sealing portion of the shell and the shell portion of the upper shield located between the first crimp and the second crimp.

2. The sealed joint of claim 1, further comprising a gasket interposed in the sealed joint between the sealing portion of the shell and the shell portion of the upper shield.

3. The sealed joint of claim 1, wherein the gasket comprises talc.

4. The sealed joint of claim 1, wherein the shell portion of the upper shield is plastically or elastically deformed between the first crimp and the second crimp.

5. The sealed joint of claim 1, wherein the outer section diameter is about 11 mm.

6. The sealed joint of claim 5, wherein the second crimp diameter is about 9.9 mm.

7. A method of making a sealed joint for a gas sensor, comprising the steps of:
forming a sensor shell having an attachment portion and a sealing portion, the sealing portion having an inner section and an outer section terminating at a free end of the shell, the outer section having an outer section diameter and the inner section having an inner section diameter, wherein the outer section diameter is greater than the inner section diameter;
forming an upper shield having a shell portion adapted for disposition around the sealing portion of the shell and a connector portion extending upwardly away from the shell portion;
placing the shell portion of the upper shield over the sealing portion of the shell;
crimping the upper shield to form a first radial crimp proximate the inner section which generally conforms the shell portion of the upper shield to the inner section and outer section of the shell; and
crimping the upper shield to form a second radial crimp in the connector portion proximate the shell portion, the second crimp having a crimp diameter which is less than the outer section diameter of the shell; whereby a sealed joint is formed between the sealing portion of the shell and the shell portion of the upper shield located between the first crimp and the second crimp.

8. The method of claim 7, wherein the steps of crimping the first radial crimp and crimping the second radial crimp is performed as a single crimping step.

9. The method of claim 7, further comprising a step of placing a gasket between the sealing portion of the shell and the shell portion of the upper shield prior to crimping.

10. The method of claim 7, wherein the step of placing a gasket comprises depositing a ring of a fluid gasket material.

11. The method of claim 10, wherein the fluid gasket material is a mixture of talc and an alcohol.

12. The sealed joint of claim 1, wherein the step of crimping further comprises plastically or elastically deforming the shell portion of the upper shield between the first crimp and the second crimp.
